(19) United States
(12) Patent Application Publication
(10) Pub. No.: US 2025/0133434 A1
(43) Pub. Date: Apr. 24, 2025

(54) MEASUREMENT CONFIGURATION FOR TERMINAL DEVICE

(71) Applicant: Nokia Technologies Oy, Espoo (FI)

(72) Inventors: Muhammad TAYYAB, Oulu (FI); Navin HATHIRAMANI, Dallas, TX (US); Nitin MANGALVEDHE, Naperville, IL (US)

(21) Appl. No.: 18/917,420

(22) Filed: Oct. 16, 2024

(30) Foreign Application Priority Data
Oct. 24, 2023 (GB) 2316224.1

(51) Int. Cl. H04W 24/10; H04W 72/51

(52) U.S. Cl. CPC H04W 24/10; H04W 72/51

(57) ABSTRACT

Embodiments of the present disclosure relate to a terminal device, a method and a medium for modifying or adapting a measurement configuration for a terminal device. In an aspect, a terminal device determines at least one of at least one scheduling restriction or at least one measurement configuration based on one or more conditions including an energy state of the terminal device. The terminal device transmits, to a network device, a request for modifying a configuration for performing measurements. The request comprises at least one of the at least one scheduling restriction or the at least one measurement configuration. With the embodiments in the present disclosure, the preferred measurement configuration and scheduling restrictions can be dynamically provided based on the priority and the energy state of the UE, and thus the energy consumption of energy harvesting devices can be reduced.

### FIELD

Various example embodiments generally relate to the field of communication, and in particular, to a terminal device, a method, an apparatus and a computer readable storage medium for modifying or adapting a measurement configuration for a terminal device.

### BACKGROUND

In current the third generation partnership project (3GPP) the fifth generation (5G) new radio (NR) standards, a user equipment (UE) requires measurement gaps (MGs) to identify and measure intra-frequency cells, inter-frequency cells and/or inter radio access technology (inter-RAT) evolved universal terrestrial radio access (E-UTRAN) cells, i.e., for handover purposes. A user equipment (UE) receives MG configuration from the network through radio resource control (RRC) signaling, and performs measurement of neighboring cells during MGs. During these measurements, the UE stops transmission and reception with the serving cell (S-cell) and measures the neighboring cells.

### SUMMARY

In general, example embodiments of the present disclosure provide a solution for modifying or adapting a measurement configuration for a terminal device. For example, the solution provided by the example embodiments of the present disclosure can dynamically provide the preferred measurement configuration and scheduling restrictions based on the priority and the energy state of the UE, and thus can reduce the energy consumption of energy harvesting devices when they are in high need of energy.

In a first aspect, there is provided a terminal device. The terminal device may comprise at least one processor; and at least one memory storing instructions that, when executed by the at least one processor, cause the terminal device at least to: determine at least one of at least one scheduling restriction or at least one measurement configuration based on one or more conditions including an energy state of the terminal device; and transmit, to a network device, a request for modifying a configuration for performing measurements, wherein the request comprises at least one of the at least one scheduling restriction or the at least one measurement configuration.

In a second aspect, there is provided a method. The method may comprise: determining, at a terminal device, at least one of at least one scheduling restriction or at least one measurement configuration based on one or more conditions including an energy state of the terminal device; and transmitting, to a network device, a request for modifying a configuration for performing measurements, wherein the request comprises at least one of the at least one scheduling restriction or the at least one measurement configuration.

In a third aspect, there is provided an apparatus. The apparatus may comprise: means for determining, at a terminal device, at least one of at least one scheduling restriction or at least one measurement configuration based on one or more conditions including an energy state of the terminal device; and means for transmitting, to a network device, a request for modifying a configuration for performing measurements, wherein the request comprises at least one of the at least one scheduling restriction or the at least one measurement configuration.

In a fourth aspect, a non-transitory computer readable medium comprising program instructions for causing an apparatus to perform a method comprising: determining, at a terminal device, at least one of at least one scheduling restriction or at least one measurement configuration based on one or more conditions including an energy state of the terminal device; and transmitting, to a network device, a request for modifying a configuration for performing measurements, wherein the request comprises at least one of the at least one scheduling restriction or the at least one measurement configuration.

In a fifth aspect, there is provided a computer program comprising instructions, which, when executed by an apparatus, cause the apparatus at least to: determine at least one of at least one scheduling restriction or at least one measurement configuration based on one or more conditions including an energy state of the terminal device; and transmit, to a network device, a request for modifying a configuration for performing measurements, wherein the request comprises at least one of the at least one scheduling restriction or the at least one measurement configuration.

In a sixth aspect, there is provided a terminal device. The terminal device may comprise determining circuitry configured to determine at least one of at least one scheduling restriction or at least one measurement configuration based on one or more conditions including an energy state of the terminal device; and transmitting circuitry configured to transmit, to a network device, a request for modifying a configuration for performing measurements, wherein the request comprises at least one of the at least one scheduling restriction or the at least one measurement configuration.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, in which:

FIG. 1A illustrates example network environment in which example embodiments of the present disclosure may be implemented;

FIG. 1B illustrates an example of a measurement gap repetition period (MGRP) and a measurement gap length (MGL);

FIG. 1C illustrates an example signaling process of MG settings;

FIG. 2 illustrates an example signaling process of modifying or adapting a measurement configuration for a terminal device in accordance with some example embodiments of the present disclosure;

FIG. 3 illustrates another example signaling process of modifying or adapting a measurement configuration for a terminal device in accordance with some example embodiments of the present disclosure;

FIG. 4 illustrates yet another example signaling process of modifying or adapting a measurement configuration for a terminal device in accordance with some example embodiments of the present disclosure;

FIG. 5 illustrates an example flowchart of a process for determining the scheduling restrictions, MGRP, and MGL in accordance with some example embodiments of the present disclosure;

FIG. 6 illustrates an example flowchart of a method of modifying or adapting a measurement configuration for a terminal device in accordance with some example embodiments of the present disclosure;

FIG. 7 illustrates an example simplified block diagram of a device that is suitable for implementing embodiments of the present disclosure; and

FIG. 8 illustrates an example block diagram of an example computer readable medium in accordance with some embodiments of the present disclosure.

Throughout the drawings, the same or similar reference numerals represent the same or similar element.

### DETAILED DESCRIPTION

Principles of the present disclosure will now be described with reference to some example embodiments. It is to be understood that these embodiments are described only for the purpose of illustration and to help those skilled in the art to understand and implement the present disclosure, without suggesting any limitation as to the scope of the disclosure. The disclosure described herein may be implemented in various manners other than the ones described below.

In the following description and claims, unless defined otherwise, all technical and scientific terms used herein have the same meaning as commonly understood by one of ordinary skills in the art to which the present disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It may be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof. As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory (ies) that work together to cause an apparatus, such as a mobile phone or server, to perform various functions) and
(c) hardware circuit(s) and or processor(s), such as a microprocessor(s) or a portion of a microprocessor(s) that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as long term evolution (LTE), LTE-advanced (LTE-A), wideband code division multiple access (WCDMA), high-speed packet access (HSPA), narrow band Internet of things (NB-IoT) and so on. Furthermore, the communications between a terminal device and a network device in the communication network may be performed according to any suitable generation communication protocols, including, but not limited to, the third generation (3G), the fourth generation (4G), 4.5G, the fifth generation (5G) communication protocols, the 6G communication protocols and/or beyond. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a NR NB (also referred to as a gNB), a remote radio unit (RRU), a radio header (RH), a remote radio head (RRH), a relay, a low power node such as a femto, a pico, and so forth, depending on the applied terminology and technology.

The term “terminal device” refers to any end device that may be capable of wireless communication. By way of example rather than limitation, a terminal device may also be referred to as a communication device, user equipment (UE), a subscriber station (SS), a portable subscriber station, a mobile station (MS), or an access terminal (AT). The terminal device may include, but not limited to, a mobile phone, a cellular phone, a smart phone, voice over IP (VoIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial, a relay node, an integrated access and backhaul (IAB) node, and/or industrial wireless networks, and the like. In the following description, the terms “terminal device”, “communication device”, “terminal”, “user equipment” and “UE” may be used interchangeably.

As used herein, the term “resource”, “transmission resource”, “resource block”, “physical resource block” (PRB), “uplink (UL) resource” or “downlink (DL) resource” may refer to any resource for performing a communication, for example, a communication between a terminal device and a network device, such as a resource in time domain, a resource in frequency domain, a resource in space domain, a resource in code domain, a resource in a combination of more than one domain or any other resource enabling a communication, and the like. In the following, a resource in time domain (such as, a subframe) will be used as an example of a transmission resource for describing some example embodiments of the present disclosure. It is noted that example embodiments of the present disclosure are equally applicable to other resources in other domains.

As discussed above, 3GPP technical specification (TS) 38.331 shows the possibility that an MG can be repeated with periodicity, which is called measurement gap repetition period (MGRP) of {20, 40, 80, 160} milliseconds (ms). Similarly, each MG lasts a fixed duration called measurement gap length (MGL) that can be configured as {1.5, 3, 3.5, 4, 5.5, 6} ms. The combination of different MGL and MGRP can be configured and is called MG pattern. The MGRP is set ideally to match exactly the synchronization signal block (SSB) periodicity and MGL is set to match the duration of the neighbor SSBs that the UE needs to measure. During the MGL the S-cell knows not to schedule the UE for downlink (DL) resources but whether a measurement is done within an MG or not is left up to UE implementation.

The use of ambient internet of things (AIoT) devices, i.e., devices that are battery-less or devices that have batteries but don't need battery replacement over the lifetime of the device is being studied within the 3GPP framework (currently a release (Rel)-19 study item in service and system aspects working group 1 (SA1) and a potential Rel-19 radio access network (RAN) working group-led study item). Based on the ongoing 3GPP studies, there is a need for improved coverage (i.e., 30 meters (m) indoor and up to 100 m outdoor) and increased device density with ultra-low-cost and power consumption that is not addressed by existing solutions (i.e., a radio frequency identification (RFID) that has coverage up to 10 m). AIOT devices are expected to have lower complexity, data rate, coverage, cost, and energy consumption than narrow band IoT (NB-IoT)/enhanced machine type communication (eMTC).

The use cases for ambient IoT devices may include identification, tracking, monitoring, sensing, logistics and supply chain management, transportation, manufacturing (factory automation), healthcare, energy, agriculture, transportation, smart cities, environment, extreme conditions, and hazardous environments in some use cases (environments where devices with batteries is not an option).

The design targets of AIOT devices may include the following: improved link budget compared to RFID solutions; frequency bands for global useability; ultra-low-cost; no need for battery charging or replacement (enabling low maintenance long life cycle operation); ultra-low-power (e.g., <100 micro-Watts, to enable operation with back-scattering or energy harvesting); small device size, form-factor; positioning accuracy (e.g., 3-5m); data rate (e.g., 10-100 kbps); energy source: ambient devices: use of backscattering techniques, semi-ambient devices: devices operating with energy harvesting or with a very small battery (e.g., <100 mAh); and mobile-originated and mobile-terminated data.

As per the 3GPP RAN #101 outcome, the RAN plenary study on AIoT has been completed. The technical report TR 38.848 contains the agreed connectivity topologies and deployment scenarios for ambient IoT, including consideration of different AIoT device type (A, B and C) based on storage or without storage capability. The following set of ambient IoT devices are considered in the study item: 1) Device A: no energy storage, no independent signal generation (i.e., backscattering transmission); 2) Device B: has energy storage, no independent signal generation (i.e., backscattering transmission). Use of stored energy can include amplification for reflected signals; and 3) Device C: has energy storage, has independent signal generation (i.e., active RF component for transmission).

In type C energy harvesting devices with active transmission and storage, transmission is similar to NR UE, so access protocols can still be used with some changes. The main difference is the lack of stable power availability. For RF energy harvesting, power and signal construction could be different (different waveforms). Furthermore, energy harvesting signal is usually broadcast and other UEs can benefit energy harvesting signal when transmitted for one user. There is also a proposal 3 that device C2: an active device with full capabilities to perform both network registration (uplink (UL) & downlink (DL)) and both machine originated (MO) and machine terminated (MT) operations.

When applying MGs for energy harvesting (EH) UEs (e.g., RP-230058, AIoT Device type C2), the prioritization rules for measurements and data may not be suitable due to the dynamic energy arrival at the EH UE side. The neighbor cells measurements are power consuming and this could increase data latency due to the device having to wait until it can harvest additional energy before it can complete data transfer. As the EH device has limited energy resources, there should be a mechanism to dynamically adjust MGs, e.g., by looking at the UL buffer status report and data priority to identify whether to prioritize the data or measurements.

However, the conventional MG setting is not suitable for EH devices since there is a need to dynamically adjust the network-determined MG setting due to dynamic energy arrivals especially when the network is not aware (or fully aware) of energy harvesting device (EHD) energy levels. Therefore, a solution is needed to overcome the problem of measurement failures resulting from varying energy conditions at the UE and rules for prioritization of measurements over data.

Therefore, example embodiments of the present disclosure provide a solution for modifying or adapting a measurement configuration for a terminal device, especially, for device type C which is an active device with full capabilities to perform both MO and MT operations. According to the example embodiments of modifying or adapting a measurement configuration for a terminal device as provided in the present disclosure, the preferred measurement configuration and scheduling restrictions can be dynamically provided based on the priority and the energy state of the UE, and thus the energy consumption of energy harvesting devices can be reduced.

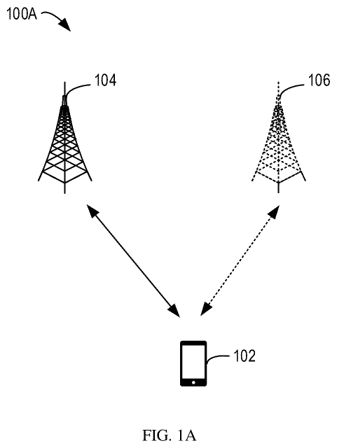

For illustrative purposes, principles and example embodiments of the present disclosure of modifying or adapting a measurement configuration for a terminal device will be described below with reference to FIG. 1A-FIG. 8. However, it is to be noted that these embodiments are given to enable the skilled in the art to understand inventive concepts of the present disclosure and implement the solution as proposed herein, and not intended to limit scope of the present application in any way.

Reference is made to FIG. 1A, which illustrates an example of a communication network 100A in which some example embodiments of the present disclosure may be implemented. As illustrated in FIG. 1A, the communication network 100A includes a terminal device (which may also be referred to as user equipment or UE) 102 and a network device (which may also be referred to as a gNB or base station) 104. Although the terminal device 102 and the network device 104 are shown in FIG. 1A, the numbers of the network devices and the terminal devices are not limited. For example, the communication network 100A may comprise a network device 106. In other words, there may be one or more network devices and one or more terminal devices in the communication network 100A.

In communication network 100A, UE 102 may be, for example, a type C IoT device or an EHD. In the present disclosure, the terms “UE” and “EHD” may be used interchangeably. UE 102 may signal a preferred prioritization of measurements/data. UE 102 may signal a preferred configuration for MGRP and MGL to the gNB 104. The gNB 104 may take UE preferences (e.g., scheduling or MG preferences based on its energy level) into account when scheduling. UE 102 may determine to dynamically adjust an MG by, for example, looking at the UL buffer status report (BSR) and/or data priority to identify whether to prioritize the data or measurements. For example, if the energy of the UE battery is low, UE 102 may prioritize data transmission instead of measurements.

It is to be understood that the number of devices and their connection relationships and types shown in FIG. 1A are for illustrative purposes without suggesting any limitation. The communication system 100A may comprise any suitable number of devices adapted for implementing embodiments of the present disclosure.

Reference is made to FIG. 1B, which illustrates an example 100B of an MGRP and an MGL. As shown in FIG. 1B, the MGRP 120 is fixed to 40 ms and MGL 4 ms. An MG occurs at 110 with MGL of 4 ms. After the MGRP 120, another MG occurs at 130. The combinations of different MGL and MGRP can be configured and is called the MG pattern.

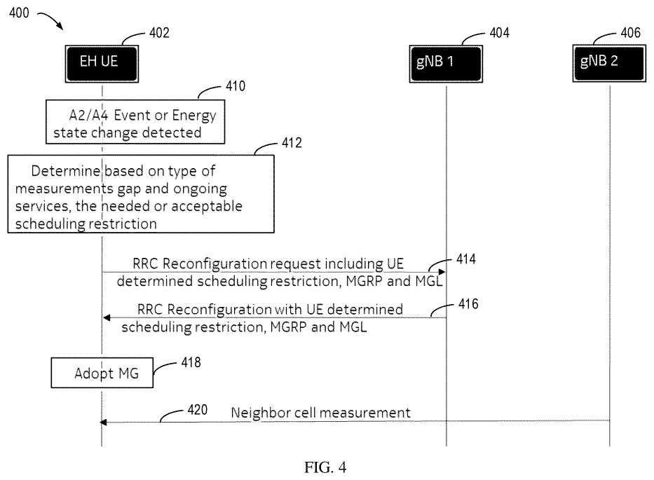

Reference is made to FIG. 1C, which illustrates an example signaling process 100C of MG settings. At 150, the EH UE 140 sends its measurement capability to the serving gNB (i.e., gNB 142). At 152, the gNB 142 provides a measurement gap configuration to the EH UE 140. At 154, the EH UE 140 adopts the MG. At 156, the EH UE 140 starts neighbor cell measurements (i.e., reference signal (e.g., SSB or channel state information reference signal (CSI-RS)) measurements from gNB 144). At 158, the EH UE 140 failed to receive and/or process the reference signals due to its low energy availability. All this may result in inefficient MG decisions for EH devices: the MG may be adopted when it shouldn't be, or the MG may not be adopted when it could or should be applied. Measurement failures may result from varying energy conditions at the UE and rules for prioritization of measurements over data (see, e.g., FIG. 5). It can be seen that there is a need to dynamically adjust the network-determined MG setting due to dynamic energy arrival(s), especially when the network is not aware (or fully aware) of EHD energy levels.

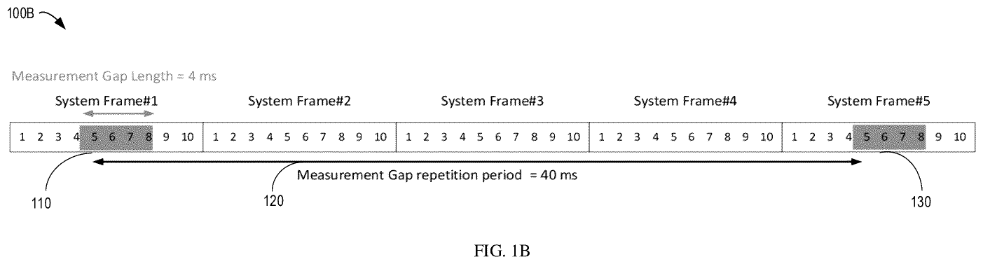

Reference is made to FIG. 2, which illustrates an example signaling process 200 of modifying or adapting a measurement configuration for a terminal device in accordance with some example embodiments of the present disclosure.

The terminal device 102 determines at least one of at least one scheduling restriction or at least one measurement configuration based on one or more conditions including an energy state of the terminal device 102. The terminal device 102 transmits (204) a request 208 for modifying a configuration for performing measurements to the network device 104. The request 208 comprises at least one of the at least one scheduling restriction or the at least one measurement configuration. The network device 104 receives (206) the request 208 from the terminal device 102.

In some example embodiments, the terminal device 102 may be an energy harvesting device. In some example embodiments, the at least one measurement configuration may comprise at least one of an MGRP or an MGL. In some embodiments, the at least one scheduling restriction may comprise at least one of a restriction on scheduling of uplink data, a restriction on scheduling of downlink data, a restriction on monitoring of downlink channels, a restriction on transmission of uplink control channels, or a time period for application of the at least one scheduling restriction.

In some example embodiments, the one or more conditions may comprise at least one of: a received measurement configuration, one or more ongoing services, a priority associated with communication with a serving cell, a priority associated with the measurements, a priority associated with data, an energy harvesting capability of the terminal device 102, a buffer status, a historical mobility pattern of the terminal device 102, a signal strength of the serving cell, a variation of the signal strength of the serving cell, an energy state of the terminal device 102, a quality of the serving cell associated with the terminal device 102, or a change in the energy state of the terminal device 102.

In some example embodiments, the terminal device 102 may determine the at least one of the at least one scheduling restriction or the at least one measurement configuration by determining a priority of a measurement to be performed in an MG and a priority of available data. For example, the terminal device 102 may decide it wants to prioritize its energy for measurements and reporting rather than for QoS and could request the network to suspend all scheduling of data until a measurement report is sent. For another example, there may be many types of measurements that the terminal device 102 performs e.g., serving beam, serving cell and cell measurements. The terminal device 102 may determine what it wants to request based on relative prioritization of measurements and data. If measurement has a higher priority (i.e., data has a lower priority), the terminal device 102 may request suspension of data scheduling with or without a change in the measurement configuration. If data has a higher priority (i.e., measurement has a lower priority), the terminal device 102 may request a longer measurement gap repetition period.

In some example embodiments, the terminal device 102 may determine an MGRP and an MGL based on an energy state with respect to different energy thresholds. For example, the terminal device 102 may apply a first MGRP and a first MGL based on determining that the energy state is no greater than a first energy threshold. For another example, the terminal device 102 may apply a second MGRP and a second MGL based on determining that the energy state is greater than the first energy threshold and no greater than a second energy threshold which is greater than the first energy threshold. The second MGRP is smaller than the first MGRP with the same or longer MGL or the second MGL is longer than the first MGL with the same or smaller MGRP.

As a further example, the terminal device 102 may apply a third MGRP and a third MGL based on determining that the energy state is greater than the second energy threshold. The third MGRP is smaller than the second MGRP with the same or longer MGL or the third MGL is longer than the second MGL with the same or smaller MGRP.

For the better illustrative purpose, these examples can be summarized as three cases. Case 1: energy state 1 (low energy state): Ecurrent≤Eth1, high MGRP (e.g., 160 ms) with low MGL (e.g., 1.5 ms) is recommended; case 2: energy state 2 (medium energy state): Eth1<Ecurrent≤Eth2, where Eth1<Eth2, medium MGRP (e.g., 80 ms) with medium MGL (e.g., 3 ms) is recommended; and case 3: energy state 3 (high energy state): Ecurrent>Eth2, lowest MGRP (e.g., 20 ms) with highest MGL (e.g., 6 ms) is recommended.

In some example embodiments, the terminal device 102 may whether the terminal device 102 is stationary and has low priority data to be transmitted. If the terminal device 102 is a stationary terminal device having low priority data to be transmitted, the terminal device 102 may determine not to apply MGs. For example, the terminal device 102 may determine that it does not need to perform any measurements based on the low priority of the data, its UL BSR, energy condition, and its past mobility patterns.

In some example embodiments, if the terminal device 102 is not a stationary terminal device having low priority data to be transmitted, the terminal device 102 may determine whether the energy state is no greater than a third energy threshold. For example, the terminal device 102 may determine, based on its EH capability or history, that it needs more idle time between the currently configured MGs to harvest additional energy outside of the MG duration and could then propose a larger MGRP.

If the terminal device 102 determines that the energy state is no greater than the third energy threshold, the terminal device 102 may determine to apply a larger MGRP than an MGRP indicated by MG settings and a smaller MGL than an MGL indicated by MG settings. If the terminal device 102 determines that the energy state is above the third energy threshold, the terminal device 102 may determine whether to support a mobility for a duration of a timer. If the terminal device 102 determines not to support the mobility for the duration of the timer, the terminal device 102 may determine to stop MGs and schedule a transmission or reception of the available data in an increased frequency. For example, in case that the network is not aware (or fully aware) of EHD energy levels, the terminal device 102 may inform the network that it prefers not to support mobility for a timer T which could be based on the expected or current RRM relaxation timer or could be based on UE mobility prediction e.g. pedestrian UE with 3 km/h speed may not need MGs for timer T (and therefore measurements would be wasteful), so the measurement gaps can be removed, thereby providing the UE with more energy for data transmission and reception. If the call drops, the network can consider it a “UE-based release”.

In some example embodiments, if the terminal device 102 determines to support the mobility for the duration of the timer, the terminal device 102 may apply an MG indicated by MG settings.

In some example embodiments, the terminal device 102 may receive a feedback indication associated with the request 208 from the network device 104. The terminal device 102 may perform the measurements based on the feedback indication.

In some example embodiments, the feedback indication may comprise a radio resource control reconfiguration message, and the radio resource control reconfiguration message may comprise the request 208. In some example embodiments, the feedback indication may comprise one of an acknowledgement of the request, a negative acknowledgment of the request, or a new configuration for performing the measurements.

In some example embodiments, the terminal device 102 may perform the measurements and the energy harvesting as modified based on the request if the feedback indication comprises the acknowledgment of the request 208. In some example embodiments, the terminal device 102 may perform the measurements based on the configuration for performing the measurements if the feedback indication comprises the negative acknowledgment of the request 208. In some example embodiments, the terminal device 102 may perform the measurements based on the new configuration if the feedback indication comprises the new configuration for performing the measurements.

In some example embodiments, the terminal device 102 may determine not to perform the measurements based on at least one of a priority of the available data being below a priority threshold, a BSR, the energy state or a past mobility pattern of the terminal device. The terminal device 102 may prevent from transmitting an indication of an A2 event or an A4 event to the network device 104. In some example embodiments, the terminal device 102 may receive the configuration for performing the measurements from the network device 104.

Generally, the example embodiments as provided by FIG. 2 proposes a solution to adapt MG configuration and restrictions on UE operation based on UE priority and energy state. The EHD determines if it accepts the restrictions on UE operation as is or if it needs to be conditionally expanded (i.e., prioritizing UE energy for measurements or prioritizing UE energy for data or UE needs large MGRP to have a little more idle time to harvest additional energy outside of the MGL under certain conditions which could be related to data priority, size of data, etc.)

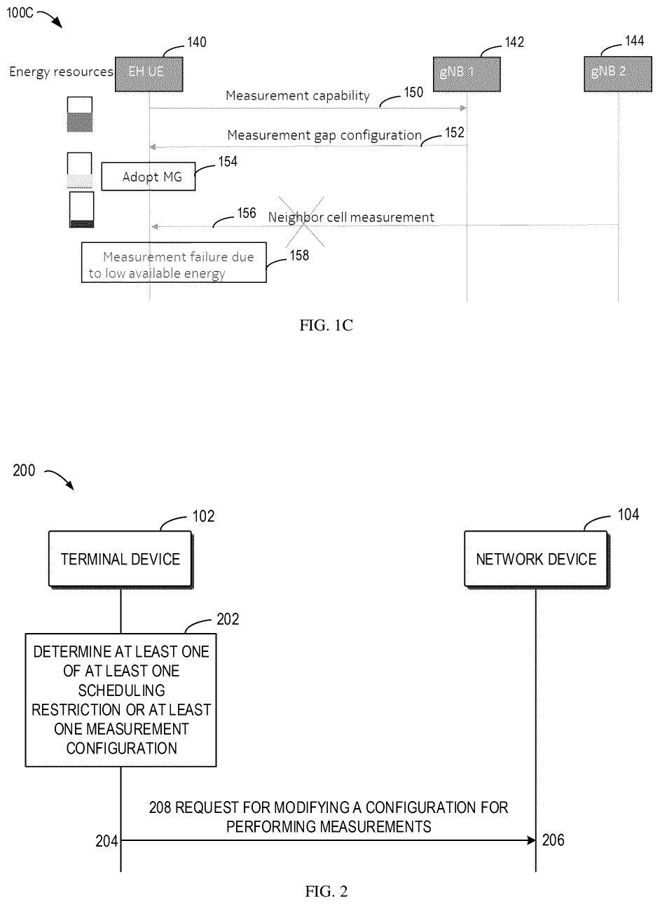

By implementing embodiments of signaling process 200, the preferred measurement configuration and scheduling restrictions can be dynamically provided based on the priority and the energy state of the UE, and thus the energy consumption of energy harvesting devices can be reduced. In some example embodiments, QoS of EH devices is improved when their energy arrival or energy storage is high. Some more specific example embodiments of modifying or adapting a measurement configuration for a terminal device will be described with reference to FIGS. 3-5.

Reference is made to FIG. 3, which illustrates another example signaling process 300 of modifying or adapting a measurement configuration for a terminal device in accordance with some example embodiments of the present disclosure. EH UE 302 in FIG. 3 may correspond to UE 102 in FIG. 1A. gNB 304 in FIG. 3 may correspond to gNB 104 in FIG. 1A. gNB 306 in FIG. 3 may correspond to gNB 106 in FIG. 1A.

In general, as the energy level of an EHD may increase or decrease (unlike conventional a battery), a dynamic MG configuration process may be necessary to exploit the full benefits of energy harvesting. The energy harvesting mechanism usually correlates; for example, in the case of solar energy, energy may be harvested during the day, but not at night. If energy is not being harvested for some time, it may be wasteful to spend energy on measurements. If energy is not being harvested, the EHD may decide whether to prioritize the U-plane or C-plane (i.e., connectivity). For example, if the EHD has little data in the UL buffer and is not receiving any DL data, it may prioritize data over measurements. Alternatively, if the EHD has data in the buffer for UL and/or is receiving DL data (high priority based on 5QI), it may prioritize measurements.

At 310, UE 302 may provide its measurement capability(s) to the gNB 304. At 312, gNB 304 may provide RRC reconfiguration(s), including generic initial measurement configuration (e.g., objects, reporting, and MG configuration (MGL, MGRP, etc.). At 314, UE 302 may determine if it accepts the restrictions on UE operation as is (i.e., without adaptation/modification), or if the restrictions on UE operation need to be expanded. UE 302 may determine, based on the type of MG and ongoing service(s), the scheduling restrictions, MGRP, and MGL, for example as shown in FIG. 5.

In some example embodiments, if inter radio access technology (IRAT) handovers have been configured for coverage, then UE 302 may decide it wants to prioritize the use of its energy for measurements and reporting, rather than for quality of service (QoS) of communication with the serving cell, and may request that the network suspend all scheduling of data until a measurement report is sent. The MG settings may be determined from the energy availability, which may be energy conditions, expected energy arrival conditions, or stored energy conditions. For example: Case 1: Energy State 1 (low energy state): Ecurrent≤Eth1,high MGRP (e.g., 160 ms) with low MGL (e.g., 1.5 ms) is recommended; Case 2: Energy State 2 (medium energy state): Eth1<Ecurrent≤Eth2, where Eth1<Eth2, medium MGRP (e.g., 80ms) with medium MGL (e.g., 3 ms) is recommended; and Case 3: Energy State 3 (high energy state): Ecurrent>Eth2, lowest MGRP (e.g., 20 ms) with highest MGL (e.g., 6 ms) is recommended.

In some example embodiments, UE 302 may also determine that it does not need to perform any measurements based on the low priority of the data, its UL BSR, energy condition, its past/historical mobility patterns, and/or a (variation of) signal strength of the serving cell. It is to be noted that networks do not consider UL/DL BSR when triggering mobility events.

In some example embodiments, UE 302 may determine, based on its EH capability or history, that it needs more idle time between the currently configured MGs to harvest additional energy outside of the MG duration, and may then propose a larger MGRP.

In some example embodiments, in case the network is not aware (or fully aware) of EHD energy levels, UE 302 may inform the network that it prefers not to support mobility for a timer T, which could be based on the expected or current radio resource management (RRM) relaxation timer, or could be based on a UE mobility prediction (e.g., pedestrian UE with 3 km/h speed may not need MGs for timer T (and therefore measurements would be wasteful)), so the measurement gaps may be removed, thereby providing the UE 302 with more energy for data transmission and reception. If the call drops (e.g., radio link failure), the network may consider it a “UE-based release”.

At 316, UE 302 may send an RRC Reconfiguration complete message, which may include UE-determined scheduling restriction, MGRP, and/or MGL. The requested scheduling restriction may be a restriction with respect to scheduling of UL data. For example, the UE 302 may request to avoid scheduling of data if it is in a low energy state. This may have the technical effect of saving energy otherwise used for PDCCH monitoring. In some example embodiments, a requested scheduling restriction may be a restriction with respect to UL communication, DL communication, or both UL and DL communication. In some example embodiments, a requested scheduling restriction may be an indication that the UE 302 is currently in a low energy state and, therefore, no UL/DL data should be scheduled. In some example embodiments, a requested scheduling restriction may include a time parameter for which the scheduling restriction is valid. In some example embodiments, a requested scheduling restriction may include a restriction on monitoring of DL channels. In some example embodiments, a requested scheduling restriction may include a restriction on transmission of UL control channels.

A scheduling restriction may be indicated, for example, via an RRC message (e.g., RRC reconfiguration request message). The network may schedule communication with the EHD based, at least partially, on the requested scheduling restriction.

At 318, gNB 304 may acknowledge the selected configuration, thereby signaling acceptance of the request for the selected configuration. In some example embodiments, gNB 304 may deny the request for the UE 302's preferred configuration based on having the right/ability to override the request from the UE 302. In some example embodiments, a denial or rejection of the request may force the UE 302 to use the original configuration provided to UE 302. In some example embodiments, the gNB 304 may provide a new configuration. For example, during the RRC reconfiguration with the MG, gNB 304 may ignore the EHD requests and insist on a certain MG pattern and measurement configuration, for example based on knowing scheduling requirements and UL TX power will be optimized. The gNB 304 may determine an optimal measurement gap and configuration based on the UE timing advance (TA), provided measurements, UE location if known, etc.

In an example embodiment, the feedback indication may comprise one of an acknowledgement of the selected/requested configuration, an acceptance of the request/configuration, a negative acknowledgment of the request, a new configuration for performing the cell measurements, or a denial of the configuration.

At 320, if the UE 302 receives confirmation from gNB 304, it may adopt the measurement gap configuration that was indicated to the gNB 304 at 316. At 322, the UE 302 may continue performing neighboring cells measurements based on the configured MGs.

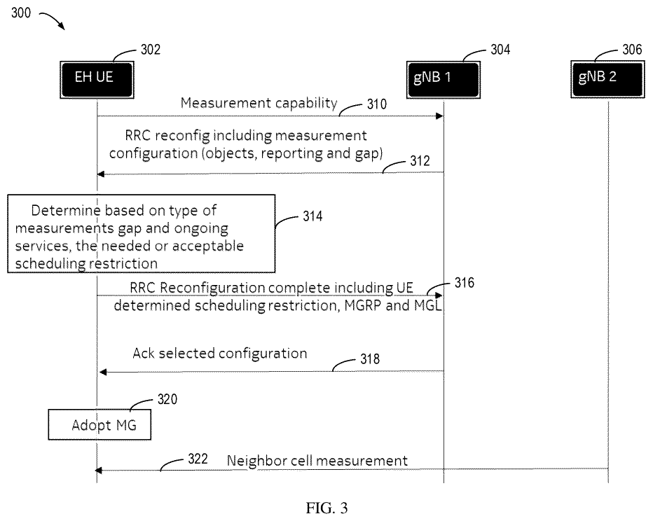

Reference is made to FIG. 4, which illustrates yet another example signaling process 400 of modifying or adapting a measurement configuration for a terminal device in accordance with some example embodiments of the present disclosure. EH UE 402 in FIG. 4 may correspond to UE 102 in FIG. 1A. gNB 404 in FIG. 4 may correspond to gNB 104 in FIG. 1A. gNB 406 in FIG. 4 may correspond to gNB 106 in FIG. 1A.

At 410, the UE 402 may detect that the serving cell quality is less than a threshold, or that there is a change in the UE's energy state. The detection may be based on events requiring inter-frequency or intra-frequency measurement events (e.g., an A2 or A4 event). In addition to any event that would normally trigger a request for RRC reconfiguration, any change in the UE energy state may also trigger UE 402 to request a new MG configuration. If the energy state is very good (e.g., the battery level of UE 402 is high), then the previously provided MG configuration may be fine/acceptable to UE 402, but if the energy level drops, then UE 402 may want to reprioritize measurements and/or data.

At 412, UE 402 may determine the needed or acceptable restrictions on UE operation, MGRP, and/or MGL upon A2 event detection, for example as shown in FIG. 5. In some example embodiments, if IRAT handovers have been configured for coverage, then UE 402 may decide that it wants to prioritize its energy for measurements and reporting, rather than for QoS, and may request that the network suspend all scheduling of data until a measurement report is sent. The MG settings may be determined from the energy availability, which may be energy conditions, expected energy arrival conditions, or stored energy conditions. For example: case 1: energy state 1 (low energy state): Ecurrent≤Eth1, high MGRP (e.g. 160 ms) with low MGL (e.g. 1.5 ms) is recommended; case 2: energy state 2 (medium energy state): Eth1<Ecurrent≤Eth2, where Eth1<Eth2, medium MGRP (e.g. 80 ms) with medium MGL (e.g. 3 ms) is recommended; and case 3: energy state 3 (high energy state): Ecurrent>Eth2, lowest MGRP (e.g. 20 ms) with highest MGL (e.g. 6 ms) is recommended.

In some example embodiment, UE 402 may also determine to not perform any measurements based on the low priority of the data, its UL BSR, energy condition, and/or its past mobility patterns. It is to be noted that networks do not consider UL/DL BSR when triggering mobility events. In this case, UE 402 may avoid sending A2/A4 to gNB 404. This may leave more power for other transmissions. If gNB 404 is informed that it could be to make the gNB 404 aware that, if the call drops, it was the UE 402 that decided it was ok (e.g., no mobility support), and the dropping of the call may be counted in that manner in the key performance indicator (KPI) (e.g., as a UE-based release).

In some example embodiments, UE 402 may determine, based on its EH capability or history, that it needs more idle time between the currently configured MGs to harvest additional energy outside of the MG duration, and may then propose a larger MGRP. In some example embodiments, in case gNB 404 is not aware (or fully aware) of the EHD energy levels, UE 402 may inform the network that it prefers not to support mobility for a timer T, which may be based on the expected or current RRM relaxation timer or could be based on UE mobility prediction. For example, a pedestrian UE with a 3 km/h speed may not need MGs for timer T (and therefore measurements may be wasteful), so the measurement gaps may be removed, thereby providing UE 402 with more energy for data transmission and reception. If the call drops, the NW may consider it a “UE-based release” (e.g., it is not because of a low signal to interference plus noise ratio (SINR)).

At 414, UE 402 may send an RRC reconfiguration request to gNB 404 with the UE-determined scheduling restrictions and MGL. At 416, gNB 404 may provide an RRC reconfiguration based on the UE determination. In some example embodiments, if UE 402 chooses not to employ the MG to prioritize the finalization of data transfer, the gNB 404 may count the RRC release with a cause different than normal as a “UE-driven decision”. In other words, if radio link failure occurs, the network may log that it is not because of low SINR, but rather is a UE based release. At 418, UE 402 may adopt the newly configured measurement gaps. At 420, UE 402 may continue to perform neighboring cells measurements based on the newly configured MGs.

Reference is made to FIG. 5, which illustrates an example flowchart of a process 500 for determining the scheduling restrictions, MGRP, and MGL in accordance with some example embodiments of the present disclosure. FIG. 5 will be described with reference to FIG. 1A.

At 502, UE 102 may receive the MG settings from the gNB 104. UE 102 may determine, based on the type of MG, ongoing services, and/or scheduling restrictions, a preferred MGRP and/or MGL, for example, by implementing all or some of blocks 504 to 520.

At 504, UE 102 may determine if IRAT handover has occurred. For example, if IRAT handovers have been configured for coverage then UE 102 may decide it wants to prioritize its energy for measurements and reporting rather than for QoS and could request the network to suspend all scheduling of data until a measurement report is sent. The MG settings could be determined from the energy availability which could be energy conditions, expected energy arrival conditions, or stored energy conditions. For example, based on case 1, case 2 or case as discussed above.

If yes (i.e., IRAT handover has occurred), the process 500 continues to 506. At 506, UE 102 may determine to suspend scheduling of data and apply MGs based on the EH device energy levels. If no (i.e., IRAT handover has not occurred), the process 500 continues to 508. At 508, UE 102 may determine if UE 102 is stationary, for example, based on past mobility pattern with low priority data using UL BSR. For example, UE 102 may also determine it's not performing any measurements based on the low priority of the data, its UL BSR, energy condition, and its past mobility patterns. Networks may not consider UL/DL BSR when triggering mobility events. UE 102 may avoid sending A2/A4 to gNB, e.g., since this would leave more power for other transmissions.

If yes (i.e., UE 102 is stationary), the process 500 continues to 510. At 510, UE 102 may determine to not apply MGs. If no (i.e., UE 102 is not stationary), the process 500 continues to 512. At 512, UE 102 may determine if the energy is low. If yes, the process 500 continues to 514. At 514, UE 102 may determine to propose larger MGRP to increase idle time to harvest energy outside MGL. If no, the process 500 continues to 516. At 516, UE 102 may determine if there is no mobility support for timer T. for example, UE 102 may determine, based on its EH capability or history, that it needs more idle time between the currently configured MGs to harvest additional energy outside of the MG duration and could then propose a larger MGRP.

If yes (i.e., there is no mobility support for timer T), the process 500 continues to 518. At 518, UE 102 may determine to stop MGs and schedule UE data more frequently. If the call drops, the network may consider it a “UE based release.” If no (i.e., there is mobility support for timer T), the process 500 continues to 520. At 520, UE 102 may continue with the network indicated MG settings. For example, in case network is not aware (or fully aware) of EHD energy levels, UE 102 may inform the network that it prefers not to support mobility for a timer T which could be based on the expected or current RRM relaxation timer or could be based on UE mobility prediction e.g. pedestrian UE with 3 km/h speed may not need MGs for timer T (and therefore measurements would be wasteful), so the measurement gaps can be removed, thereby providing UE 102 with more energy for data transmission and reception. If the call drops, the network can consider it a “UE-based release.

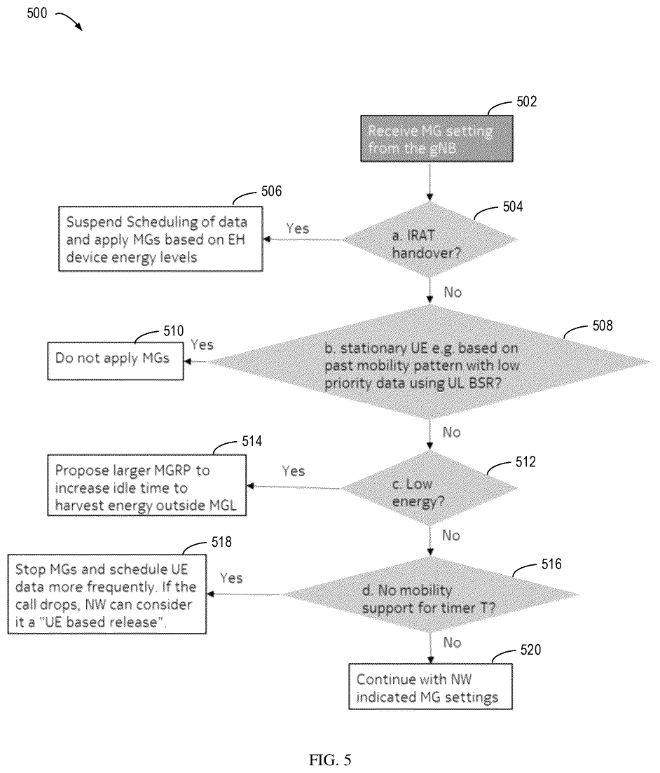

Reference is made to FIG. 6, which illustrates an example flowchart of a method 600 of modifying or adapting a measurement configuration for a terminal device in accordance with some example embodiments of the present disclosure. FIG. 6 will be described with reference to FIG. 1A.

At 602, a terminal device 102 determines at least one of at least one scheduling restriction or at least one measurement configuration based on one or more conditions including an energy state of the terminal device.

At 604, the terminal device 102 transmits, to a network device 104, a request for modifying a configuration for performing measurements. The request comprises at least one of the at least one scheduling restriction or the at least one measurement configuration.

It is to be understood that the method 600 may comprise further steps corresponding to the example embodiments as provided by FIG. 2, and thus for the purpose of simplification, herein, the further steps will not be described again. By implementing the example embodiments as provided by the method 600, the preferred measurement configuration and scheduling restrictions can be dynamically provided based on the priority and the energy state of the UE, and thus the energy consumption of energy harvesting devices can be reduced. In some example embodiments, QoS of EH devices is improved when their energy arrival or energy storage is high.

In some example embodiments, an apparatus capable of performing the method 600 (for example, the terminal device 102) may comprise means for performing the respective steps of the method 600. The means may be implemented in any suitable form. For example, the means may be implemented in a circuitry or software module.

In some example embodiments, the apparatus may comprise means for determining, at a terminal device, at least one of at least one scheduling restriction or at least one measurement configuration based on one or more conditions including an energy state of the terminal device; and means for transmitting, to a network device, a request for modifying a configuration for performing measurements, wherein the request comprises at least one of the at least one scheduling restriction or the at least one measurement configuration.

In some example embodiments, the means for determining the at least one of the at least one scheduling restriction or the at least one measurement configuration may comprise means for determining a priority of a measurement to be performed in an MG and a priority of available data.

In some example embodiments, the means for determining a priority of a measurement to be performed in an MG and a priority of available data may comprise means for determining an MGRP and an MGL based on an energy state with respect to different energy thresholds.

In some example embodiments, the means for determining an MGRP and an MGL based on an energy state with respect to different energy thresholds may further comprise means for based on determining that the energy state is no greater than a first energy threshold, applying a first MGRP and a first MGL; means for based on determining that the energy state is greater than the first energy threshold and no greater than a second energy threshold which is greater than the first energy threshold, applying a second MGRP and a second MGL, wherein the second MGRP is smaller than the first MGRP with the same or longer MGL or the second MGL is longer than the first MGL with the same or smaller MGRP; and means for based on determining that the energy state is greater than the second energy threshold, applying a third MGRP and a third MGL, wherein the third MGRP is smaller than the second MGRP with the same or longer MGL or the third MGL is longer than the second MGL with the same or smaller MGRP.

In some example embodiments, the means for determining the at least one of the at least one scheduling restriction or the at least one measurement configuration may further comprise means for determining whether the terminal device is a stationary terminal device having low priority data to be transmitted; and means for based on determining that the terminal device is a stationary terminal device having the low priority data to be transmitted, determining not to apply MGs.

In some example embodiments, the means for determining the at least one of the at least one scheduling restriction or the at least one measurement configuration may further comprise means for based on determining that the terminal device is not a stationary terminal device having the low priority data to be transmitted, determining whether the energy state is no greater than a third energy threshold; and means for based on determining that the energy state is no greater than the third energy threshold, determining to apply a larger MGRP than an MGRP indicated by MG settings and a smaller MGL than an MGL indicated by MG settings.

In some example embodiments, the means for determining the at least one of the at least one scheduling restriction or the at least one measurement configuration may further comprise means for based on determining that the energy state is above the third energy threshold, determining whether to support a mobility for a duration of a timer; means for based on determining not to support the mobility for the duration of the timer, determining to stop MGs; and means for scheduling a transmission or reception of the available data in an increased frequency.

In some example embodiments, the means for determining the at least one of the at least one scheduling restriction or the at least one measurement configuration may further comprise means for based on determining to support the mobility for the duration of the timer, applying an MG indicated by MG settings.

In some example embodiments, the means for determining the at least one of the at least one scheduling restriction or the at least one measurement configuration may further comprise means for receiving, from the network device, a feedback indication associated with the request; and means for performing the measurements based on the feedback indication.

In some example embodiments, the feedback indication may comprise a radio resource control reconfiguration message, and the radio resource control reconfiguration message may comprise the request.

In some example embodiments, the feedback indication may comprise one of an acknowledgement of the request, a negative acknowledgment of the request, or a new configuration for performing the measurements.

In some example embodiments, the apparatus may further comprise means for in response to the feedback indication comprising the acknowledgment of the request, performing the measurements and the energy harvesting as modified based on the request; means for in response to the feedback indication comprising the negative acknowledgment of the request, performing the measurements based on the configuration for performing the measurements; and means for in response to the feedback indication comprising the new configuration for performing the measurements, performing the measurements based on the new configuration.

In some example embodiments, the apparatus may further comprise means for determining not to perform the measurements based on at least one of a priority of the available data being below a priority threshold, a BSR, the energy state or a past mobility pattern of the terminal device; and means for preventing from transmitting an indication of an A2 event or an A4 event to the network device.

In some example embodiments, the apparatus may further comprise means for receiving, from the network device, the configuration for performing the measurements

In some example embodiments, the apparatus may further comprise means for performing other steps in some embodiments of the method 600. In some example embodiments, the means comprises at least one processor and at least one memory including computer program code, the at least one memory and computer program code configured to, with the at least one processor, cause the performance of the apparatus.

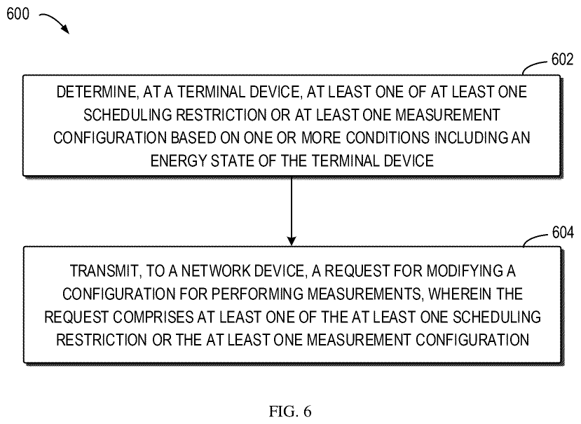

Reference is made to FIG. 7, which illustrates an example simplified block diagram of a device 700 that is suitable for implementing embodiments of the present disclosure. The device 700 may be provided to implement the communication device, for example the terminal device 102 as shown in FIG. 1A. As shown, the device 700 includes one or more processors 710, one or more memories 720 may couple to the processor 710, and one or more communication modules 740 may couple to the processor 710.

The communication module 740 is for bidirectional communications. The communication module 740 has at least one antenna to facilitate communication. The communication interface may represent any interface that is necessary for communication with other network elements, for example the communication interface may be wireless or wireline to other network elements, or software based interface for communication.

The processor 710 may be of any type suitable to the local technical network and may include one or more of the following: general purpose computers, special purpose computers, microprocessors, digital signal processors (DSPs) and processors based on multicore processor architecture, as non-limiting examples. The device 700 may have multiple processors, such as an application specific integrated circuit chip that is slaved in time to a clock which synchronizes the main processor.

The memory 720 may include one or more non-volatile memories and one or more volatile memories. Examples of the non-volatile memories include, but are not limited to, a read only memory (ROM) 724, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 722 and other volatile memories that will not last in the power-down duration.

A computer program 730 includes computer executable instructions that are executed by the associated processor 710. The program 730 may be stored in the ROM 724. The processor 710 may perform any suitable actions and processing by loading the program 730 into the RAM 722.

The embodiments of the present disclosure may be implemented by means of the program so that the device 700 may perform any process of the disclosure as discussed with reference to FIG. 6. The embodiments of the present disclosure may also be implemented by hardware or by a combination of software and hardware.

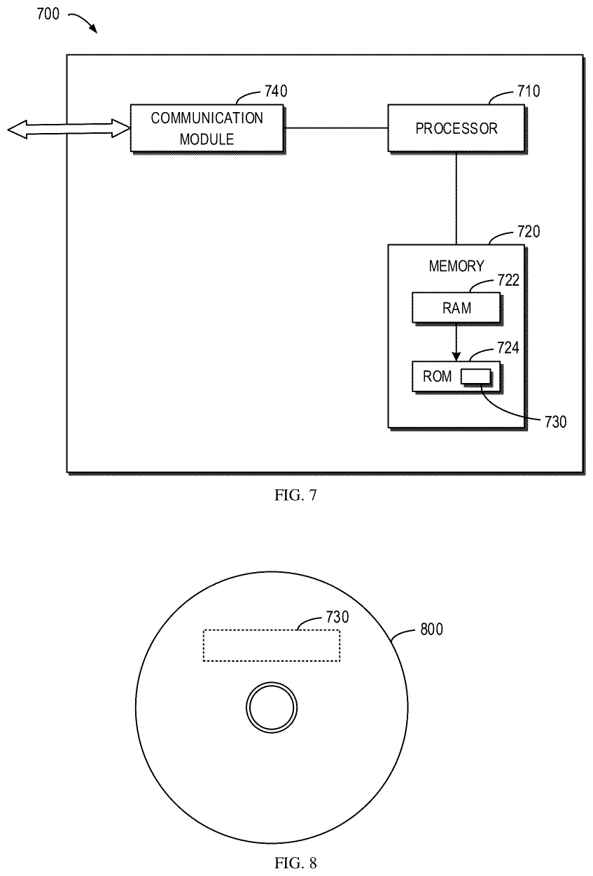

In some embodiments, the program 730 may be tangibly contained in a computer readable medium which may be included in the device 700 (such as in the memory 720) or other storage devices that are accessible by the device 700. The device 700 may load the program 730 from the computer readable medium to the RAM 722 for execution. The computer readable medium may include any types of tangible non-volatile storage, such as ROM, EPROM, a flash memory, a hard disk, CD, DVD, and the like. FIG. 8 shows an example of the computer readable medium 800 in form of CD or DVD. The computer readable medium has the program 730 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the method 600 as described above with reference to FIG. 6. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. The term “non-transitory,” as used herein, is a limitation of the medium itself (i.e., tangible, not a signal) as opposed to a limitation on data storage persistency (e.g., RAM vs. ROM).

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

What is claimed is:

1. A terminal device comprising:
at least one processor; and
at least one memory storing instructions that, when executed by the at least one processor, cause the terminal device at least to:
determine at least one of at least one scheduling restriction or at least one measurement configuration based on one or more conditions including an energy state of the terminal device; and
transmit, to a network device, a request for modifying a configuration for performing measurements, wherein the request comprises at least one of the at least one scheduling restriction or the at least one measurement configuration.

2. The terminal device of claim 1, wherein the terminal device is caused to determine the at least one of the at least one scheduling restriction or the at least one measurement configuration by:
determining a priority of a measurement to be performed in a measurement gap (MG) and a priority of available data.

3. The terminal device of claim 2, wherein the terminal device is further caused to determine a measurement gap repetition period (MGRP) and a measurement gap length (MGL) based on an energy state with respect to different energy thresholds.

4. The terminal device of claim 3, wherein the terminal device is further caused to determine an MGRP and an MGL based on an energy state with respect to different energy thresholds by:
based on determining that the energy state is no greater than a first energy threshold, applying a first MGRP and a first MGL;
based on determining that the energy state is greater than the first energy threshold and no greater than a second energy threshold which is greater than the first energy threshold, applying a second MGRP and a second MGL, wherein the second MGRP is smaller than the first MGRP with the same or longer MGL or the second MGL is longer than the first MGL with the same or smaller MGRP; or
based on determining that the energy state is greater than the second energy threshold, applying a third MGRP and a third MGL, wherein the third MGRP is smaller than the second MGRP with the same or longer MGL or the third MGL is longer than the second MGL with the same or smaller MGRP.

5. The terminal device of claim 2, wherein the terminal device is further caused to determine the at least one of the at least one scheduling restriction or the at least one measurement configuration by:
determining whether the terminal device is a stationary terminal device having low priority data to be transmitted; and
based on determining that the terminal device is a stationary terminal device having the low priority data to be transmitted, determining not to apply MGs.

6. The terminal device of claim 5, wherein the terminal device is further caused to determine the at least one of the at least one scheduling restriction or the at least one measurement configuration by:
based on determining that the terminal device is not a stationary terminal device having the low priority data to be transmitted, determining whether the energy state is no greater than a third energy threshold; and
based on determining that the energy state is below the third energy threshold, determining to apply a larger MGRP than an MGRP indicated by MG settings and a smaller MGL than an MGL indicated by MG settings.

7. The terminal device of claim 6, wherein the terminal device is further caused to determine the at least one of the at least one scheduling restriction or the at least one measurement configuration by:
based on determining that the energy state is above the third energy threshold, determining whether to support a mobility for a duration of a timer;
based on determining not to support the mobility for the duration of the timer, determining to stop MGs; and
scheduling a transmission or reception of the available data in an increased frequency.

8. The terminal device of claim 7, wherein the terminal device is further caused to determine the at least one of the at least one scheduling restriction or the at least one measurement configuration by:
based on determining to support the mobility for the duration of the timer, applying an MG indicated by MG settings.

9. The terminal device of claim 1, wherein the terminal device is further caused to:
receive, from the network device, a feedback indication associated with the request; and
perform the measurements based on the feedback indication.

10. The terminal device of claim 9, wherein the feedback indication comprises a radio resource control reconfiguration message, and wherein the radio resource control reconfiguration message comprises the request.

11. The terminal device of claim 9, wherein the feedback indication comprises one of an acknowledgement of the request, a negative acknowledgment of the request, or a new configuration for performing the measurements.

12. The terminal device of claim 11, wherein the terminal device is further caused to:
in response to the feedback indication comprising the acknowledgment of the request, perform the measurements and the energy harvesting as modified based on the request;
in response to the feedback indication comprising the negative acknowledgment of the request, perform the measurements based on the configuration for performing the measurements; and
in response to the feedback indication comprising the new configuration for performing the measurements, perform the measurements based on the new configuration.

13. The terminal device of claim 5, wherein the terminal device is further caused to:
determine not to perform the measurements based on at least one of a priority of the available data being below a priority threshold, a buffer status report (BSR), the energy state or a past mobility pattern of the terminal device; and
prevent from transmitting an indication of an A2 event or an A4 event to the network device.

14. The terminal device of claim 1, wherein the terminal device comprises an energy harvesting device.

15. The terminal device of claim 1, wherein the terminal device is further caused to:
receive, from the network device, the configuration for performing the measurements.

16. The terminal device of claim 1, wherein the one or more conditions comprises at least one of:
a received measurement configuration,
one or more ongoing services,
a priority associated with communication with a serving cell,
a priority associated with the measurements,
a priority associated with data,
an energy harvesting capability of the terminal device,
a buffer status,
a historical mobility pattern of the terminal device,
a signal strength of the serving cell,
a variation of the signal strength of the serving cell,
an energy state of the terminal device,
a quality of the serving cell associated with the terminal device, or
a change in the energy state of the terminal device.

17. The terminal device of claim 1, wherein the at least one measurement configuration comprises at least one of:
an MGRP, or
an MGL.

18. The terminal device of claim 1, wherein the at least one scheduling restriction comprises at least one of:
a restriction on scheduling of uplink data,
a restriction on scheduling of downlink data,
a restriction on monitoring of downlink channels,
a restriction on transmission of uplink control channels, or
a time period for application of the at least one scheduling restriction.

19. A method comprising:
determining, at a terminal device, at least one of at least one scheduling restriction or at least one measurement configuration based on one or more conditions including an energy state of the terminal device; and
transmitting, to a network device, a request for modifying a configuration for performing measurements, wherein the request comprises at least one of the at least one scheduling restriction or the at least one measurement configuration.

20. An apparatus:
determine, at a terminal device, at least one of at least one scheduling restriction or at least one measurement configuration based on one or more conditions including an energy state of the terminal device; and
transmit, to a network device, a request for modifying a configuration for performing measurements, wherein the request comprises at least one of the at least one scheduling restriction or the at least one measurement configuration.
